(19) United States
(12) Patent Application Publication
(10) Pub. No.: US 2024/0215477 A1
(43) Pub. Date: Jul. 4, 2024

(54) INSTRUCTION DEVICE, BEHAVIOR PLAN INSTRUCTION SYSTEM, AND DRIVING ROUTE CREATION METHOD

(71) Applicant: HONDA MOTOR CO., LTD., Tokyo (JP)

(72) Inventors: Andrii PYDIN, Saitama (JP); Koichi TSUNO, Saitama (JP)

(21) Appl. No.: 18/148,415

(22) Filed: Dec. 29, 2022

(51) Int. Cl. A01D 34/00; G05D 1/02

(52) U.S. Cl. CPC A01D 34/008; G05D 1/0214; G05D 1/027; G05D 1/0285; A01D 2101/00

(57) ABSTRACT

Provided is an instruction device capable of generating a driving route suitable for characteristics of a driving region while reducing the number of steps required to generate a route. The instruction device is configured to instruct an autonomous driving vehicle of a behavior plan including at least a driving route, the driving route includes an actual driving route created based on actual driving data obtained at the time of actual driving, and the actual driving route is set at a predetermined position on the driving route, based on the actual driving data.

### BACKGROUND OF THE INVENTION

### Field of the Invention

The present invention relates to an instruction device, a behavior plan instruction system, and a driving route creation method.

### Related Art

Japanese Unexamined Patent Application, Publication No. S63-000604 discloses a technique for creating a driving course covering the inside of a work area by teaching an outer circumference of the entire work area for an unmanned working vehicle.
Patent Document 1: Japanese Unexamined Patent Application, Publication No. S63-000604

### SUMMARY OF THE INVENTION

Each work area has different characteristics. When the work area is, for example, a lawn mowing area, the lawn mowing area may be flat or may not be flat as a whole. The lawn mowing area may include a place where the ground is inclined or a place where the ground is uneven. Such a place is defined as a place with remarkable characteristics within the work area. In the place with the remarkable characteristics, an unmanned vehicle is required to drive in consideration of such characteristics. This is because, when the vehicle is driven in not consideration of the characteristics, for example, when the unmanned vehicle is a lawnmower, the lawnmower may overturn or get stuck.

The conventional technique does not consider the characteristics of the place with the remarkable characteristics at the time of creating a driving route. The present invention has been made in view of such a problem. The present invention is to provide an instruction device capable of generating a driving route suitable for characteristics of a driving region while reducing the number of steps required to generate a route.
(1) The present invention provides an instruction device configured to instruct an autonomous driving vehicle of a behavior plan including at least a driving route, in which, the driving route includes an actual driving route created based on actual driving data obtained at the time of actual driving, and the actual driving route is set at a predetermined position on the driving route, based on the actual driving data.
(7) The present invention provides a method of creating a driving route for an autonomous driving vehicle, the method of creating the driving route including: an actual driving step of causing the autonomous driving vehicle to drive in a driving region; a dangerous zone determining step of determining, based on actual driving data acquired at the time of actual driving, a dangerous zone included in the driving region; and a driving route creating step of creating a driving route when the autonomous driving vehicle drives in the driving region, the driving route creating step including fixing a driving route in the dangerous zone to a route in which the autonomous driving vehicle drives in the actual driving step.

According to the instruction device or the driving route creation method, an applicable range of the actual driving route is set based on the actual driving data, and thus it is possible to determine a range to which actual driving should be applied and a position that can be arbitrarily set or changed, whereby it is possible to increase flexibility of route generation while increasing the possibility of driving.
(2) In the instruction device according to (1), the actual driving route is set at a position, where the actual driving data exceeds a threshold, on the driving route.

According to the instruction device of (2), the actual driving route is applied to the location where the actual driving data exceeds the threshold, and thus it is possible to further increase the possibility of driving.
(3) In the instruction device according to (2), a position where the actual driving data is equal to or less than the threshold is provided such that the actual driving route is changeable.

According to the instruction device of (3), the driving route can be arbitrarily set for the location where the actual driving data is equal to or less than the threshold, and thus it is possible to increase flexibility of route generation while maintaining the possibility of driving.
(4) In the instruction device according to (2) or (3), the actual driving data is at least data of a yaw angular velocity or an acceleration in an up-down direction of the autonomous driving vehicle.

According to the instruction device of (4), since unevenness may exist on a road surface, it is possible to further increase the possibility of driving by applying the actual driving route.
(5) In the instruction device according to any one of (2) to (4), the behavior plan includes a driving condition for the autonomous driving vehicle, and sets a driving condition based on the actual driving data at the position where the actual driving data exceeds the threshold.

According to the instruction device of (5), the driving condition during actual driving is applied to the location where the actual driving data exceeds the threshold, and thus it is possible to further increase the possibility of driving.
(6) The present invention provides a behavior plan instruction system including the instruction device according to any one of (1) to (5) and the autonomous driving vehicle, in which, the instruction device is provided in a server, the autonomous driving vehicle transmits the actual driving data to the server, and the autonomous driving vehicle receives the behavior plan from the server.

According to the behavior plan instruction system of the present invention, since the instruction device is provided in the server, the equipment of the autonomous driving vehicle can be simplified. In addition, it is possible to efficiently instruct the behavior plan from one server to a plurality of autonomous driving vehicles.

According to the present invention, it is possible to provide an instruction device capable of generating a driving route suitable for characteristics of a driving region while reducing the number of steps required to generate a route.

### BRIEF DESCRIPTION OF THE DRAWINGS

FIG. 1 is a schematic configuration diagram of a behavior plan instruction system of an embodiment of the present embodiment;

FIG. 2 is a schematic configuration diagram of a management server;

FIG. 3 is a diagram showing a driving region and a ruled driving route;

FIG. 4 is a diagram showing a procedure for creating a contour of a driving region;

FIG. 5 is a diagram showing a dangerous zone;

FIG. 6 is a diagram showing a driving route in a dangerous zone;

FIG. 7 is a diagram showing a non-dangerous zone divided with a mesh;

FIG. 8 is a diagram showing a driving route

FIG. 9 is a diagram showing another driving route;

FIG. 10 is a flowchart showing a flow of creating a driving route;

FIG. 11 is a diagram showing a case where two dangerous zones exist in a driving region;

FIG. 12 is a diagram showing another case where two dangerous zones exist in a driving region.

### DETAILED DESCRIPTION OF THE INVENTION

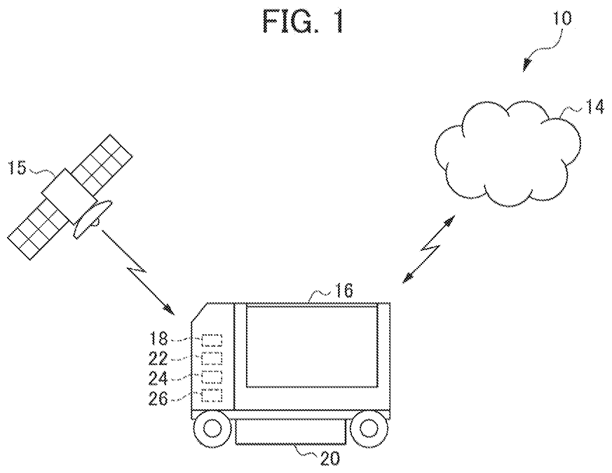

A detailed description of the invention will be described with reference to the drawings. FIG. 1 is a schematic configuration diagram of a behavior plan instruction system 10 of the present embodiment.

The behavior plan instruction system 10 includes an autonomous driving vehicle 16 and a management server 14. An example of the autonomous driving vehicle 16 includes an autonomous driving lawnmower. The autonomous driving vehicle 16 is not limited to the autonomous driving lawnmower. The autonomous driving vehicle 16 is not limited to a working vehicle such as the autonomous driving lawnmower. The autonomous driving vehicle 16 may drive under control from a human in addition to an autonomous driving. The autonomous driving vehicle 16 may be configured to be ridden by a person. The autonomous driving vehicle 16 may be configured to allow a person who rides on the autonomous driving vehicle 16 to control the drive of the autonomous driving vehicle 16.

Hereinafter, the autonomous driving vehicle 16 will be described by taking the autonomous driving vehicle 16 as the autonomous driving lawnmower as an example. The autonomous driving lawnmower is referred to as a self-propelled type lawnmower 16. It is assumed that the self-propelled type lawnmower 16 is configured to be ridden by a person. The self-propelled type lawnmower 16 may be configured to allow a person who rides on the self-propelled type lawnmower 16 to control the drive of the self-propelled type lawnmower 16.

The autonomous driving vehicle 16 includes a position sensor 18, a cutting blade 20, a communicator 22, an inertial measurement device 24, and a control computer 26.

The position sensor 18 acquires position information using GNSS (Global Navigation Satellite System). An example of GNSS includes GPS (Global Positioning System). In a case of using the GPS, the position sensor 18 communicates with a GPS satellite 15 to obtain position information of the position sensor 18.

The position information is information indicating coordinates of the current self-location and a current time. The coordinates include latitude and longitude. The time can be represented as a timestamp. The position sensor 18 transmits the position information to the management server 14 via the communicator 22.

The cutting blade 20 is a cutter for cutting a lawn. The cutting blade 20 can have a plurality of cutters.

The inertial measurement device 24 is a device that acquires information relating an acceleration, an angular velocity, and an attitude of the autonomous driving vehicle 16. The inertial measurement device 24 is also called an IMU (Inertial Measurement Unit). Examples of the information acquired by the inertial measurement device 24 include a yaw angle of the vehicle and an acceleration in an up-down direction of the vehicle. Information indicating the yaw angle of the vehicle, the acceleration in the up-down direction of the vehicle, and the attitude of the vehicle is used as driving information.

The communicator 22 is a device that transmits the position information acquired by the position sensor 18 to the management server 14. The communicator 22 can receive various types of information from the management server 14.

The communicator 22 transmits the driving information in addition to the position information to the management server 14. Information including the position information and the driving information is used as actual driving data. The communicator 22 transmits the actual driving data to the management server 14.

The control computer 26 is a computer that controls the autonomous driving of the autonomous driving vehicle 16. The control computer 26 communicates with the management server 14 through a predetermined network. An example of the management server 14 includes a cloud server. The management server 14 may be called a server.

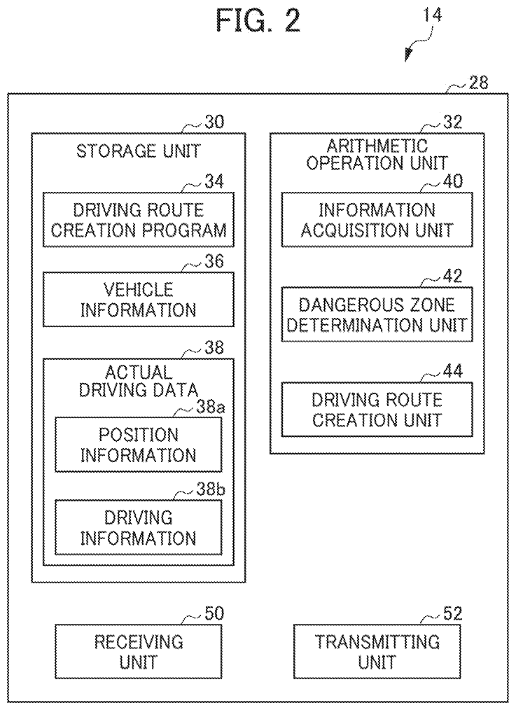

FIG. 2 is a schematic configuration diagram of the management server 14. The management server 14 is a server device that creates a driving route 60 of the autonomous driving vehicle 16.

The management server 14 includes a driving route creation device 28. The driving route creation device 28 functions as an instruction device. The driving route creation device 28 includes a storage unit 30, an arithmetic operation unit 32, a receiving unit 50, and a transmitting unit 52. The storage unit 30 can transmit and receive programs, information, and data to/from the arithmetic operation unit 32.

The receiving unit 50 receives information or the like from the autonomous driving vehicle 16. The receiving unit 50 receives, for example, actual driving data 38 transmitted from the communicator 22 of the autonomous driving vehicle 16.

The transmitting unit 52 transmits information or the like to the autonomous driving vehicle 16. The transmitting unit 52 transmits, for example, information relating the driving route to the communicator 22 of the autonomous driving vehicle 16.

The storage unit 30 includes one or more memories. The storage unit 30 may include a ROM (Read Only Memory) and a RAM (Random Access Memory). The storage unit 30 stores a driving route creation program 34 and vehicle information 36.

The driving route creation program 34 is a program for causing a computer to execute a driving route creation method.

The vehicle information 36 is information including a distance between front wheels and a distance between the front wheels and rear wheels when the autonomous driving vehicle 16 is a four-wheel vehicle. The vehicle information 36 can include the center of gravity of the autonomous driving vehicle 16. The vehicle information 36 can also be specifications. The vehicle information 36 can be set for each autonomous driving vehicle 16 according to the type of the autonomous driving vehicle 16.

The actual driving data 38 is data acquired when the autonomous driving vehicle 16 drives in a driving region. The actual driving data 38 includes position information 38a and driving information 38b. The position information 38a includes the latitude of the autonomous driving vehicle 16, the longitude of the autonomous driving vehicle 16, and the timestamp of the autonomous driving vehicle 16. The driving information 38b includes the yaw angle of the autonomous driving vehicle 16, the acceleration of the autonomous driving vehicle 16, and the attitude data of the autonomous driving vehicle 16.

The arithmetic operation unit 32 includes one or more processors. The arithmetic operation unit 32 can include a CPU (Central Processing Unit) and a GPU (Graphics Processing Unit). The arithmetic operation unit 32 can read the programs and the data stored in the storage unit 30. The arithmetic operation unit 32 includes an information acquisition unit 40, a dangerous zone determination unit 42, and a driving route creation unit 44.

The information acquisition unit 40, the dangerous zone determination unit 42, and the driving route creation unit 44 are implemented when the arithmetic operation unit 32 executes the driving route creation program 34.

The information acquisition unit 40 acquires programs, information, and data from the storage unit 30. The dangerous zone determination unit 42 determines, based on the information acquired by the information acquisition unit 40, a dangerous zone within the driving region.

The driving route creation unit 44 creates, based on the information acquired by the information acquisition unit 40, a driving route for driving in the driving region.

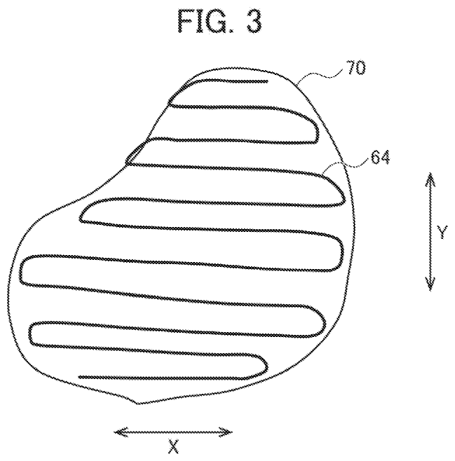

The creation of the driving route will be described with reference to FIGS. 3 to 10. FIG. 3 is a diagram showing a driving region 70 and a ruled driving route 64. A direction of an arrow X shown in FIG. 3 is defined as a horizontal direction X. A direction of an arrow Y shown in FIG. 3 is defined as a vertical direction Y.

Conventionally, when lawn mowing is performed with the self-propelled type lawnmower 16, the self-propelled type lawnmower 16 can automatically generate a regular driving route in a case of knowing a contour of a region where the lawn mowing is performed.

The regular driving route means the following route. The region where the lawn mowing is performed is defined as the driving region 70 of the self-propelled type lawnmower 16. The self-propelled type lawnmower 16 drives in the driving region 70 up to an end in the horizontal direction X of the driving region 70. At the end, the self-propelled type lawnmower 16 moves by a width of the lawn mowing in the vertical direction Y. After moving, the self-propelled type lawnmower 16 drives up to an opposite end of the driving region 70 in a direction opposite to a tip in the horizontal direction X. At the end, the self-propelled type lawnmower 16 moves by a width of the lawn mowing in the vertical direction Y. Thereafter, the same driving is repeated. The regular driving route is a route along which the self-propelled type lawnmower 16 drives in this manner. The regular driving route is defined as a ruled driving route 64.

FIG. 3 is a diagram showing an example of the ruled driving route 64. The ruled driving route 64 shown in FIG. 3 is a route in which movement in the horizontal direction X is prioritized. A direction in which the ruled driving route 64 has priority is not limited to the horizontal direction X. The direction in which the ruled driving route 64 has priority can be various directions, for example, the vertical direction Y or an inclined direction.

The ruled driving route 64 is generated such that the self-propelled type lawnmower 16 drives regularly and evenly throughout the driving region 70.

The driving region 70 is not necessarily uniform over its entire region. A part of the ground in the driving region 70 may be inclined. A part of the ground in the driving region 70 may have unevenness. A place having significantly different topography than other places, for example, the place where the ground is inclined or the place where the ground is uneven is defined as a place with remarkable characteristics. The behavior plan instruction system 10 of the present embodiment can create a driving route while taking into account the place with remarkable characteristics.

The behavior plan instruction system 10 of the present embodiment creates the driving route in the following order. A person allows the autonomous driving vehicle 16 or a vehicle similar to the autonomous driving vehicle 16 to drive throughout the driving region 70. The contour of the driving region 70 is created based on the position information of the autonomous driving vehicle 16 during driving. The creating the contour of the driving region 70 means deciding an outer shape of the driving region 70. The zone with the remarkable characteristics in the driving region is defined as a dangerous zone 70a. The dangerous zone 70a is obtained based on the driving information of the autonomous driving vehicle 16 during driving. After fixing the driving route of the dangerous zone 70a to a route on which a person walks, the driving route of the driving region 70 is created as a whole.

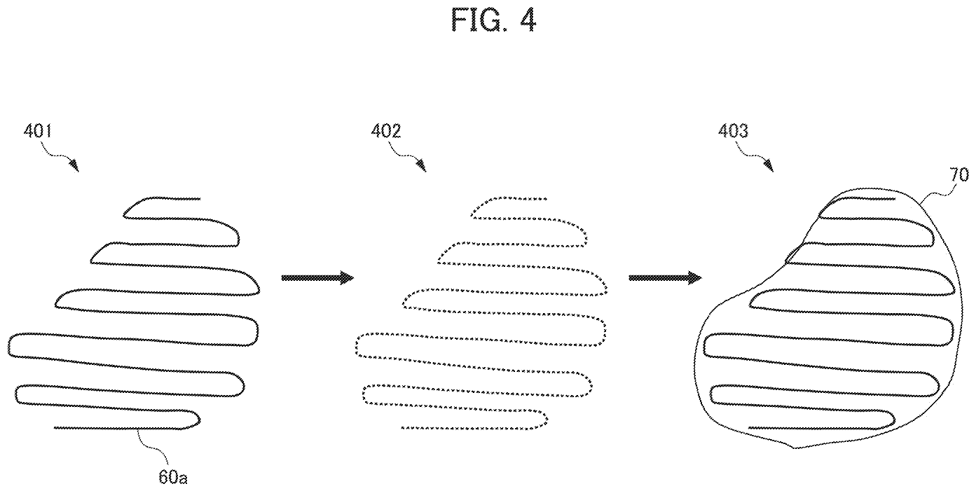

FIG. 4 is a diagram showing a procedure for creating the contour of the driving region 70. The procedure proceeds in the order of 401, 402, and 403.

Reference numeral 401 indicates an actual driving route 60a. The actual driving route 60a is a driving route when a person rides the self-propelled type lawnmower 16 and causes it to drive in the driving region 70 under steering of the person.

As indicated by 402, the self-propelled type lawnmower 16 transmits the actual driving data 38 to the management server 14 while the self-propelled type lawnmower 16 is driving in the driving region 70. The actual driving data 38 includes the position information 38a and the driving information 38b. The data transmitted to the management server 14 by the self-propelled type lawnmower 16 can include latitude and longitude, a timestamp, a yaw angle, an acceleration, and attitude data of the self-propelled type lawnmower 16. The actual driving data 38 is preferably transmitted periodically. An example of transmission cycle is 1 Hz.

Reference numeral 403 indicates the contour of the driving region 70 created based on the actual driving data 38 received from the self-propelled type lawnmower 16. The self-propelled type lawnmower 16 drives throughout the driving region 70 under control of the person. The contour of the driving region 70 is created by plotting of the actual driving data 38. The vehicle information on distance between the wheels of the vehicle is referred to as needed when the contour is created.

The person controlling the self-propelled type lawnmower 16 needs not to be riding on the self-propelled type lawnmower 16. The person may control the self-propelled type lawnmower 16 by wireless communication from a remote location without riding on the self-propelled type lawnmower 16.

Determination of the dangerous zone 70a will be described with reference to FIG. 4. The communicator 22 of the self-propelled type lawnmower 16 transmits the actual driving data 38 to the management server 14 while the self-propelled type lawnmower 16 drives in the driving region 70. The actual driving data 38 includes the driving information 38b. The driving information 38b includes information relating a yaw angle, an acceleration, and attitude data of the self-propelled type lawnmower 16.

The management server 14 determines the dangerous zone 70a based on the received driving information 38b. The dangerous zone 70a is a zone corresponding to the place with the remarkable characteristics within the driving region. Examples of the place with the remarkable characteristics include the place where the ground is inclined or the place where the ground is uneven. In the place with the remarkable characteristics, the self-propelled type lawnmower 16 is easy to overturn or easy to get stuck.

Before the self-propelled type lawnmower 16 overturns, or before the self-propelled type lawnmower 16 gets stuck, there is a symptom of overturning or getting stuck. An example of a symptom includes a case where a roll angle becomes larger. The symptom can be used for a threshold for determining that the driving is dangerous. Here, the threshold is a value that serves as a reference for determining that the driving is dangerous when the value exceeds a certain value.

An example of the threshold includes the yaw angle of the self-propelled type lawnmower 16. When the yaw angle in a left-right direction of the self-propelled type lawnmower 16 is large, it is suggested that the road surface has many unevenness. The unevenness of the road surface causes the steering wheels to be uncontrollable. The yaw angle of the self-propelled type lawnmower 16 can be used as a threshold for determining the dangerous zone 70a.

Another example of the threshold includes the acceleration in the up-down direction of the self-propelled type lawnmower 16. When the acceleration in the up-down direction of the self-propelled type lawnmower 16 is large, it is suggested that the road surface has many unevenness. The unevenness of the road surface causes the steering wheels to be uncontrollable. The acceleration in the up-down direction of the self-propelled type lawnmower 16 can be used as a threshold for determining the dangerous zone 70a.

An automatic driving safety factor will be described. The automatic driving safety factor is represented by a coefficient α. The automatic driving safety factor α is a coefficient for making it possible to grasp a route that is safe even when an automatic driving is performed by multiplying the threshold by the automatic driving safety factor α. When the automatic driving safety factor α is used, a condition for safe automatic driving satisfies a relation of data<α·threshold, which indicates the driving information during driving of the vehicle.

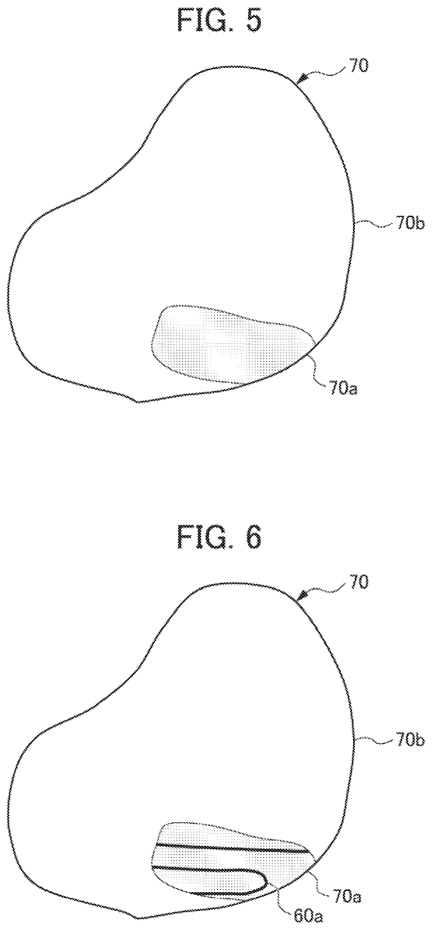

In a case of determining the dangerous zone 70a using the automatic driving safety factor α, a reference for determining the dangerous zone 70a is data≥α·threshold, which indicates the driving information during driving of the vehicle. FIG. 5 is a diagram showing the dangerous zone 70a determined using the automatic driving safety factor α. A zone other than the dangerous zone 70a in the driving region 70 is defined as a non-dangerous zone 70b. A hatched zone in the driving region 70 is a zone satisfying data≥α·threshold, which indicates the driving information during driving of the vehicle. Such a zone becomes the dangerous zone 70a. A non-hatched zone in the driving region 70 is a zone satisfying data<α·threshold, which indicates the driving information during driving of the vehicle. Such a zone becomes the non-dangerous zone 70b. The automatic driving safety factor x can be set to a value of 0.7 or more and 0.95 or less, for example.

The behavior plan instruction system 10 creates the driving route 60 in the dangerous zone 70a and the driving route 60 in the non-dangerous zone 70b in different manners. FIG. 6 is a diagram showing the driving route 60 in the dangerous zone 70a. The driving route 60 in the dangerous zone 70a is fixed to the actual driving route 60a.

In the dangerous zone 70a, the self-propelled type lawnmower 16 can drive only on the route on which a person actually walks. The dangerous zone 70a is a zone where the self-propelled type lawnmower 16 may overturn or get stuck. A person causes the self-propelled type lawnmower 16 to drive along a route where the self-propelled type lawnmower 16 does not overturn or get stuck in the dangerous zone 70a.

When the self-propelled type lawnmower 16 is a four-wheel vehicle, a distance between front wheels may differ from a distance between the front and rear wheels. The center of gravity of the self-propelled type lawnmower 16 may not be located at the center of the vehicle when viewed from above. In such a case, whether the self-propelled type lawnmower 16 overturns may be determined by an angle at which the self-propelled type lawnmower 16 is driven with respect to the unevenness or the inclination of the ground.

A person selects a driving route suitable for the ground conditions based on experience and the like. The fixing the driving route 60 of the dangerous zone 70a to the actual driving route 60a means that the self-propelled type lawnmower 16 drives along the driving route selected by the person. It can be said that the actual driving route 60a is a driving route instructed by the person. The self-propelled type lawnmower 16 can safely drive through the dangerous zone 70a by driving along the actual driving route 60a.

The non-dangerous zone 70b shown in FIG. 6 is a zone with a low danger. The behavior plan instruction system 10 can freely create a driving route without restrictions. The behavior plan instruction system 10 can set the driving route in the non-dangerous zone 70b as the ruled driving route.

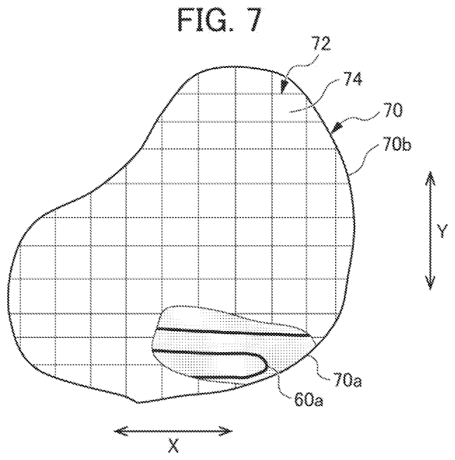

FIG. 7 is a diagram showing the non-dangerous zone 70b divided with a mesh 72. Each of parts divided with the mesh 72 is defined as a segment 74. The mesh 72 includes lines extending in the horizontal direction X and lines extending in the vertical direction Y. The segment 74 has a rectangular shape. The shape of the segment 74 is preferably square.

A width of the lawn to be mown at the time of passing of the self-propelled type lawnmower 16 is defined as a mowing width. A length of one side of the segment 74 is preferably equal to or less than the mowing width.

The driving route 60 created as a route for driving along the non-dangerous zone 70b is defined as a predetermined driving route 60b. The predetermined driving route 60b is created so as to pass through all of the segments 74 included in the non-dangerous zone 70b. The predetermined driving route 60b can be the ruled driving route 64. When the predetermined driving route 60b is the ruled driving route 64, the direction in which the ruled driving route 64 has priority can be any direction, for example, the horizontal direction X or the vertical direction Y.

When the segment 74 has the rectangular shape, an extending direction of the predetermined driving route 60b is a direction parallel or vertical to contour sides of the segment 74. A length of one side of the segment 74 is equal to or less than the mowing width. When the direction of the predetermined driving route 60b is the direction parallel or vertical to the segment 74, it is possible to prevent an unmown lawn from occurring within the driving region 70.

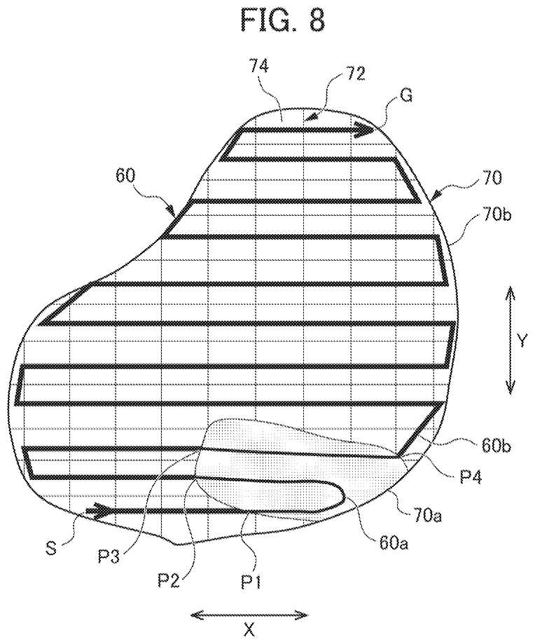

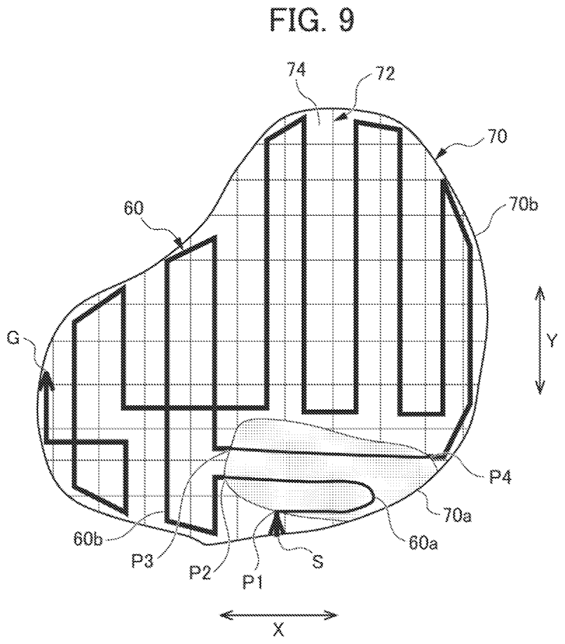

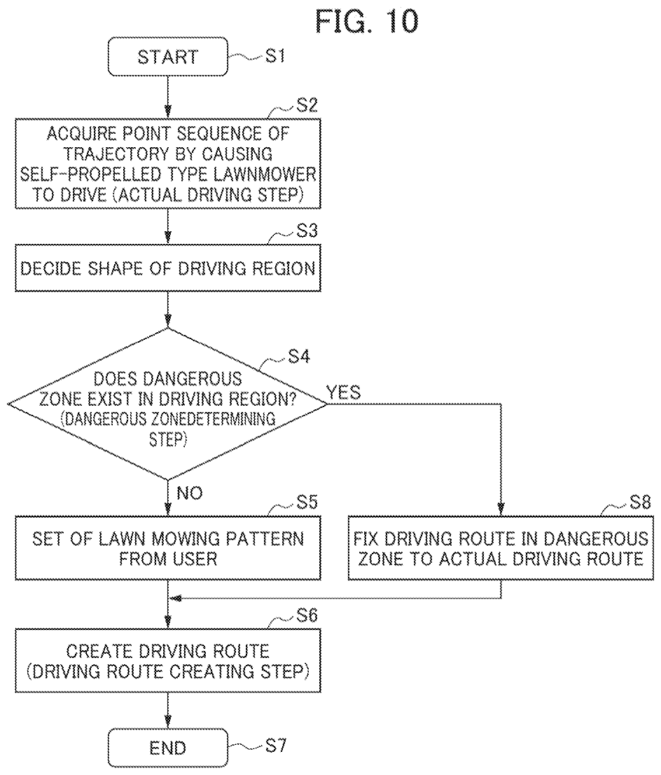

FIGS. 8 and 9 are diagrams showing the driving route 60 created by the behavior plan instruction system 10. The driving route 60 shown in FIG. 8 is a driving route 60 created so as to mow in the horizontal direction X as much as possible. The driving route 60 shown in FIG. 8 is regarded as a driving route 60 with a horizontal pattern. The driving route 60 shown in FIG. 9 is a driving route 60 created so as to mow in the vertical direction Y as much as possible. The driving route 60 shown in FIG. 9 is regarded as a driving route 60 with a vertical pattern.

The pattern of the driving route 60 is not limited to a horizontal pattern and a vertical pattern. A user of the self-propelled type lawnmower 16 can select any pattern of the driving route 60 according to his/her preference or topography. Examples of patterns other than the horizontal pattern and the vertical pattern include an inclined pattern and a circumferential pattern.

The driving route 60 starts from a start point S and ends at a goal point G. The driving route 60 passes through all segments 74 within the driving region 70. A main advancing direction of the driving route 60 with the horizontal pattern is the horizontal direction X. The driving route 60 with the horizontal pattern advances in the horizontal direction X up to an end of the driving region 70. The driving route 60 with the horizontal pattern advances by one segment in the vertical direction Y at the end of the driving region 70. After advancing in the vertical direction Y, the driving route 60 with the horizontal pattern advances in a direction opposite to the advancing direction before reaching the end. Thereafter, the driving route 60 with the horizontal pattern reaches the goal point G while switching the advancing direction in the same manner.

The driving route 60 with the vertical pattern also advances in the same manner as the driving route 60 with the horizontal pattern. In the driving route 60 with the vertical pattern and the driving route 60 with the horizontal pattern, the advancing direction is switched between the horizontal direction X and the vertical direction Y.

The driving route 60 includes an actual driving route 60a and a predetermined driving route 60b. The actual driving route 60a is the driving route 60 in the dangerous zone 70a, and the predetermined driving route 60b is the driving route 60 in the non-dangerous zone 70b.

In the driving route 60 with the horizontal pattern shown in FIG. 8, the driving route 60 starts from the start point S as the predetermined driving route 60b. The driving route 60 advances in a direction of an arrow, and reaches a point P1. At the point P1, the driving region 70 switches from the non-dangerous zone 70b to the dangerous zone 70a. At the point P1, the driving route 60 switches from the predetermined driving route 60b to the actual driving route 60a. At the point P1, the predetermined driving route 60b is connected to the actual driving route 60a. At the point P1, the driving route 60 continues without interruption.

The driving route 60 passing through the point P1 reaches a point P2. At the point P2, the driving region 70 switches from the dangerous zone 70a to the non-dangerous zone 70b. At the point P2, the driving route 60 switches from the actual driving route 60a to the predetermined driving route 60b. At the point P2, the actual driving route 60a is connected to the predetermined driving route 60b. At the point P2, the driving route 60 continues without interruption.

The driving route 60 passing through the point P2 has the same switching and connection at points P3 and P4 as those of the driving route 60 as described above. In the driving route 60 with the vertical pattern shown in FIG. 9, the driving route 60 is also switched in the same manner as the driving route 60 with the horizontal pattern.

The driving route 60 in the dangerous zone 70a is maintained in a state of being fixed to the actual driving route 60a. The driving route 60 in the dangerous zone 70a is set based on the lawn mowing method designated by the person. The self-propelled type lawnmower 16 can safely drive throughout the driving region 70 including the dangerous zone 70a.

FIG. 10 is a flowchart showing a flow of creating the driving route 60. A character S in S1 indicates a step. The meaning of S is the same for other steps.
S1 indicates a start step. The creation of the driving route 60 starts in S1.
S2 indicates an actual driving step. The user causes the self-propelled type lawnmower 16 to drive. The management server 14 acquires a point sequence of a trajectory along which the self-propelled type lawnmower 16 drives.
S3 indicates a driving region deciding step. The management server 14 decides the shape of the driving region 70. The shape of the driving region 70 is decided based on the driving trajectory of the self-propelled type lawnmower 16.
S4 indicates a dangerous zone determining step. The management server 14 collates the actual driving data with the threshold to determine whether the dangerous zone 70a exists.
S8 indicates processing step in the case where the dangerous zone 70a exists. The management server 14 fixes the driving route 60 in the dangerous zone 70a to the actual driving route 60a at the time of creating the driving route 60.
S5 indicates a step in which the user sets a lawn mowing pattern. The user designates a desired pattern such as a vertical pattern or a horizontal pattern with respect to the pattern of the lawn mowing method.
S6 indicates a driving route creating step. When there is the dangerous zone 70a, the management server 14 creates the driving route 60 of the pattern set by the user while fixing the driving route 60 in the dangerous zone 70a to the actual driving route 60a.
S7 indicates an end step. The creation of the driving route 60 ends in S7.

The flow of processing described above indicates an outline of the creation of the driving route 60. The instruction device of the present embodiment can be variously modified.

The instruction device may not be disposed in the management server 14. The instruction device may be provided on the autonomous driving vehicle 16. When the instruction device is provided on the autonomous driving vehicle 16, the control computer 26 may execute the function of the instruction device. In other words, the control computer 26 may include the function of the driving route creation device 28 of the management server 14. When the control computer 26 includes the function of the driving route creation device 28, the control computer 26 is preferably an ECU (Electronic Control Unit).

The content instructed by the instruction device is not limited to the driving route 60. The instruction device can instruct the autonomous driving vehicle 16 of a behavior plan. The behavior plan can include driving conditions and working conditions. The driving conditions can include the driving route 60, the driving velocity, and the degree of acceleration and deceleration. The working conditions are included in the behavior plan when the autonomous driving vehicle 16 is a vehicle that performs work. Examples of the work include lawn mowing, moving of a load, and moving of a person. When the autonomous driving vehicle 16 is the self-propelled type lawnmower 16, the working conditions can include a rotational speed of the cutting blade 20 and an angle of the cutting blade 20.

The content of the behavior plan instructed by the instruction device may differ between the dangerous zone 70a and the non-dangerous zone 70b. The driving conditions and the working conditions are set according to conditions of the region in which the vehicle drives.

The content of the behavior plan is not limited to being different between the dangerous zone 70a and the non-dangerous zone 70b. When a zone in which the autonomous driving vehicle 16 cannot drive exists in the driving region 70, the content of the behavior plan may be a content that avoids the zone in which the vehicle cannot drive. Examples of the zone where the autonomous driving vehicle 16 cannot drive include ponds, rocky areas, and forests.

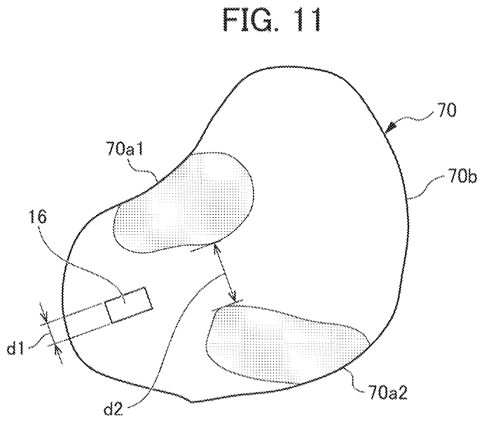

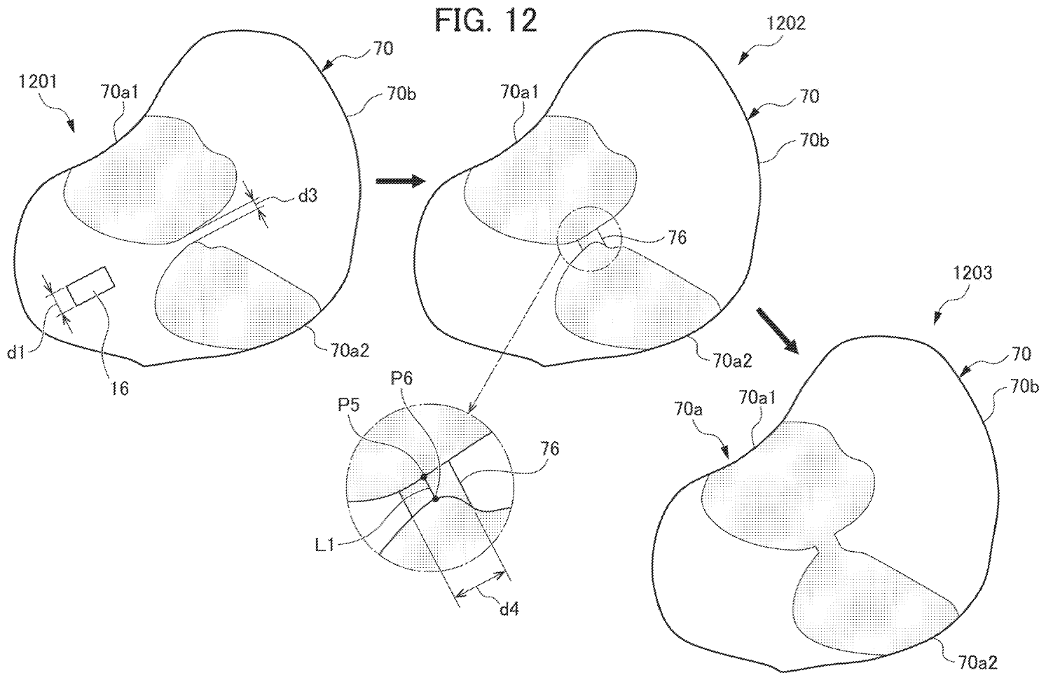

A case will be described with reference to FIGS. 11 and 12 where the driving region 70 has a plurality of dangerous zones 70a. The driving region 70 shown in FIG. 11 and the driving region 70 shown in FIG. 12 include two dangerous zones 70a. The driving region 70 shown in FIG. 11 and the driving region 70 shown in FIG. 12 are different from each other in terms of a distance between the dangerous zone 70a and the dangerous zone 70a. The distance between the dangerous zone 70a and the dangerous zone 70a is defined as an inter-dangerous zone distance. An inter-dangerous zone distance d2 shown in FIG. 11 is longer than an inter-dangerous zone distance d3 shown in FIG. 12.

A horizontal width of the self-propelled type lawnmower 16 is defined as a vehicle width d1. The inter-dangerous zone distance d2 shown in FIG. 11 is longer than the vehicle width d1. The inter-dangerous zone distance d3 shown in FIG. 12 is shorter than the vehicle width d1.

The vehicle width d1 can be a lawn mowing width of the self-propelled type lawnmower 16. The lawn mowing width can be a maximum working length of the cutting blade 20 in a direction orthogonal to the driving direction of the self-propelled type lawnmower 16.

When there are a plurality of dangerous zones 70a, the shortest distance between the dangerous zones 70a, that is, the inter-dangerous zone distance is calculated. When the inter-dangerous zone distance is longer than the vehicle width d1 of the self-propelled type lawnmower 16, each of the dangerous zones 70a is not compensated. The driving route 60 is created in a state where the dangerous zone 70a is not compensated.

In the example shown in FIG. 11, the driving region 70 includes a first dangerous zone 70a1 and a second dangerous zone 70a2. An inter-dangerous zone distance d2 between the first dangerous zone 70a1 and the second dangerous zone 70a2 is longer than the vehicle width d1. Therefore, the driving route 60 is created in the same procedures as those described with reference to FIGS. 8 and 9.

When the inter-dangerous zone distance is shorter than the vehicle width d1 of the self-propelled type lawnmower 16, each of the dangerous zones 70a is compensated. The content of the compensation is to connect two adjacent dangerous zones 70a. For two adjacent dangerous zones 70a, a constant width is imparted to a straight line connecting points with the shortest distance to the other dangerous zone 70a.

In the example shown in FIG. 12, the driving region 70 includes a first dangerous zone 70a1 and a second dangerous zone 70a2. As indicated by reference numeral 1201 in FIG. 12, an inter-dangerous zone distance d3 between the first dangerous zone 70a1 and the second dangerous zone 70a2 is shorter than the vehicle width d1. Therefore, the first dangerous zone 70a1 and the second dangerous zone 70a2 are connected to each other.

As indicated by reference numeral 1202 in FIG. 12, points P5 and P6 are points with the shortest distance between the first dangerous zone 70a1 and the second dangerous zone 70a2. A line connecting the points P5 and P6 is defined as a line L1. A width of a length d4 is imparted to the line L1. The imparted zone is a connection zone 76.

As indicated by reference numeral 1203 in FIG. 12, the first dangerous zone 70a1 and the second dangerous zone 70a2 are connected to each other through the connection zone 76. By being connected through the connection zone 76, the first dangerous zone 70a1 and the second dangerous zone 70a2 become one dangerous zone 70a. The driving route 60 is created in the same procedures as those described with reference to FIGS. 8 and 9. The actual driving route 60a in the first dangerous zone 70a1 and the actual driving route 60a in the second dangerous zone 70a2 are connected to each other through the connection zone 76.

Although the embodiment of the present invention has been described above, the present invention is not limited to the above-described embodiment, and can be variously changed, modified, and combined.

### EXPLANATION OF REFERENCE NUMERALS

10 behavior plan instruction system
14 management server
16 autonomous driving vehicle
18 position sensor
20 cutting blade
22 communicator
24 inertial measurement device
26 control computer
28 driving route creation device
30 storage unit
32 arithmetic operation unit
34 driving route creation program
36 vehicle information
38 actual driving data
38a position information
38b driving information
40 information acquisition unit
42 dangerous zone determination unit
44 driving route creation unit
60 driving route
60a actual driving route
60b predetermined driving route
64 ruled driving route
70 driving region
70a dangerous zone
70b non-dangerous zone
76 connection zone

What is claimed is:

1. An instruction device configured to instruct an autonomous driving vehicle of a behavior plan including at least a driving route, wherein
the driving route includes an actual driving route created based on actual driving data obtained at the time of actual driving, and
the actual driving route is set at a predetermined position on the driving route, based on the actual driving data.

2. The instruction device according to claim 1, wherein the actual driving route is set at a position, where the actual driving data exceeds a threshold, on the driving route.

3. The instruction device according to claim 2, wherein a position where the actual driving data is equal to or less than the threshold is provided such that the actual driving route is changeable.

4. The instruction device according to claim 2, wherein the actual driving data is at least data of a yaw angular velocity or an acceleration in an up-down direction of the autonomous driving vehicle.

5. The instruction device according to claim 2, wherein the behavior plan includes a driving condition for the autonomous driving vehicle, and sets a driving condition based on the actual driving data at the position where the actual driving data exceeds the threshold.

6. A behavior plan instruction system comprising the instruction device according to claim 1 and the autonomous driving vehicle, wherein
the instruction device is provided in a server,
the autonomous driving vehicle transmits the actual driving data to the server, and
the autonomous driving vehicle receives the behavior plan from the server.

7. A method of creating a driving route for an autonomous driving vehicle,
the method comprising:
an actual driving step of causing the autonomous driving vehicle to drive in a driving region;
a dangerous zone determining step of determining, based on actual driving data acquired at the time of actual driving, a dangerous zone included in the driving region; and
a driving route creating step of creating a driving route when the autonomous driving vehicle drives in the driving region, the driving route creating step including fixing a driving route in the dangerous zone to a route in which the autonomous driving vehicle drives in the actual driving step.
